(19) United States
(12) Patent Application Publication
(10) Pub. No.: US 2026/0348564 A1
(43) Pub. Date: Nov. 5, 2026

(54) LIGHTING LAMP

(71) Applicants: SUZHOU OPPLE LIGHTING CO., LTD., Suzhou City (CN); OPPLE LIGHTING CO., LTD., Shanghai (CN)

(72) Inventor: Caishui ZHANG, Suzhou City (CN)

(73) Assignees: SUZHOU OPPLE LIGHTING CO., LTD., Suzhou City (CN); OPPLE LIGHTING CO., LTD., Shanghai (CN)

(21) Appl. No.: 19/722,555

(22) Filed: Jun. 26, 2026

Related U.S. Application Data
(63) Continuation of application No. PCT/CN2024/143324, filed on Dec. 27, 2024.

(30) Foreign Application Priority Data
Dec. 28, 2023 (CN) 202323636649.6

(51) Int. Cl. F21V 17/16; F21V 17/00

(52) U.S. Cl. CPC F21V 17/164; F21V 17/005

(57) ABSTRACT

A lighting fixture includes a base, a lampshade, a bent buckle, and a first connection member. The base and the lampshade define opposing first and second surfaces. One of the first and second surfaces includes a first mounting hole and a raised stopper, and the bent buckle is connected to the other of the first and second surfaces. A first end of the bent buckle cooperates with the first connection member, and a second end of the bent buckle cooperates with the stopper to secure the base and the lampshade together. The first connection member, the bent buckle, and the stopper are arranged between the base and the lampshade.

### CROSS-REFERENCE TO RELATED DISCLOSURES

This disclosure is based upon and claims the priority of PCT patent disclosure No. PCT/CN 2024/143324 filed on Dec. 27, 2024, which claims priority to the Chinese patent disclosure No. 202323636649.6 filed on Dec. 28, 2023, the entire contents of which are hereby incorporated by reference herein for all purposes.

### TECHNICAL FIELD

The present disclosure belongs to the technical field of lighting product design, and particularly relates to a lighting fixture.

### BACKGROUND

With the continuous development of lighting fixtures, lighting fixtures are gradually developing in the direction of lightweight and thinness, that is, the thickness of lighting fixture may be small.

### SUMMARY

The present disclosure discloses a lighting fixture.

Accordingly, the lighting fixture may include a base, a lampshade, a bent buckle, and a first connection member for connecting the base and the lampshade. The base and the lampshade define opposing first and second surfaces, and one of the first and second surfaces is provided with a first mounting hole and a raised stopper. The bent buckle is connected to the other of the first and second surfaces such that a first end of the bent buckle cooperates with the first connection member to provide positioning in a thickness direction of the lighting fixture, while a second end of the bent buckle cooperates with the stopper to provide lateral positioning.

It is to be understood that both the foregoing general description and the following detailed description are exemplary and explanatory only and are not restrictive of the present disclosure.

### BRIEF DESCRIPTION OF DRAWINGS

FIG. 1 is a schematic sectional view of a first lighting fixture disclosed in an example of the present disclosure;

FIG. 2 is an enlarged schematic view at A in FIG. 1;

FIG. 3 is an exploded view of the first lighting fixture disclosed in the example of the present disclosure;

FIG. 4 is an exploded view of the first lighting fixture disclosed in the example of the present disclosure from a first perspective;

FIG. 5 is an enlarged schematic view at B in FIG. 4;

FIG. 6 is a schematic structural diagram of the first bent buckle disclosed in the example of the present disclosure;

FIG. 7 is a schematic structural diagram of the first bent buckle mounted on the first mounting post disclosed in the example of the present disclosure;

FIG. 8 is an enlarged schematic view at C in FIG. 7;

FIG. 9 is a schematic structural diagram of the first bent buckle and the first mounting post connected by a second connection member disclosed in the example of the present disclosure;

FIG. 10 is an enlarged schematic view at D in FIG. 9;

FIG. 11 is an exploded view of the first lighting fixture disclosed in the example of the present disclosure from a second perspective;

FIG. 12 is an enlarged schematic view at E in FIG. 11;

FIG. 13 is a schematic structural diagram of the first lighting fixture disclosed in the example of the present disclosure;

FIG. 14 is an enlarged schematic view at F in FIG. 13;

FIG. 15 is a schematic sectional view of the second lighting fixture disclosed in the example of the present disclosure;

FIG. 16 is an enlarged schematic view at G in FIG. 15;

FIG. 17 is an exploded view of the second lighting fixture disclosed in the example of the present disclosure;

FIG. 18 is a schematic structural diagram of the second bent buckle disclosed in the example of the present disclosure;

FIG. 19 is a schematic structural diagram of the second mounting post disclosed in the example of the present disclosure.

### DETAILED DESCRIPTION

In order to make the purpose, technical scheme and advantages of the present disclosure more clearly, the technical scheme in the example of the present disclosure will be described clearly and completely with the attached drawings. Clearly, the described example is a part of the example of the present disclosure, but not the whole example. Based on the examples in the present disclosure, all other examples obtained by those skilled in the art in this field without creative work belong to the protection scope of the present disclosure.

The lighting fixture disclosed in the example of the present disclosure will be described in detail through examples and application scenarios with the attached drawings.

Description of reference numerals used herein may include:

100—base, 110—first surface, 120—first mounting hole, 130—stopper, 131—guide inclined surface, 140—arc-shaped protrusion, 150—avoidance space; 200—lampshade, 210—second surface, 220—mounting post, 221—second mounting hole, 222—first protrusion, 223—second protrusion, 224—third protrusion, 225—pre-positioning portion, 2251—pre-positioning surface; 300—bend buckle, 310—first end, 320—second end, 330—first through hole, 340—first notch, 350—second notch, 360—second through hole, 370—first elastic position-limiting plate, 380—connection plate, 390—second elastic position-limiting plate; 400—first connection member, 410—third surface, 420—washer; 500—second connection member.

Sometimes, the thickness of lighting fixture may be small, and as such, the internal height space of lighting fixture may also be small. In order to facilitate the connection between the lampshade and the base of lighting fixture, threaded connection members are usually used for connection, that is, one end of the threaded connection member passes through the base and is connected with the lampshade.

However, because the threaded connection member is usually exposed outside the lighting fixture, there is a problem of increasing the thickness and size of the lighting fixture when connecting the lampshade and the base through the threaded connection member, which is not conducive to the lightweight and thinness design of the lighting fixture.

To sum up, there is a problem that the way of connecting lighting fixtures involved in the related technology is not conducive to the lightweight and thinness design of lighting fixtures.

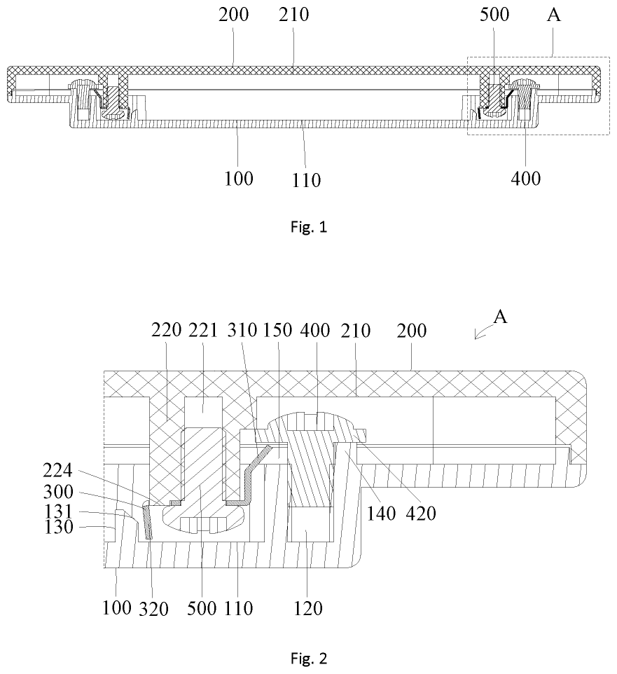

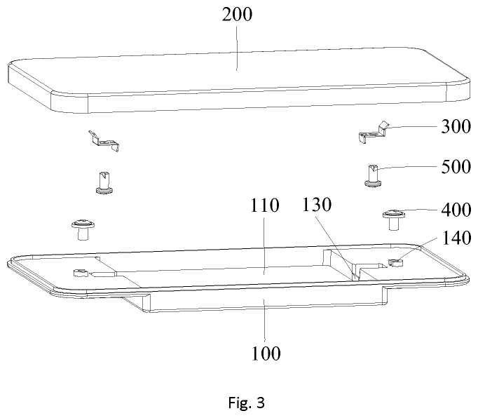

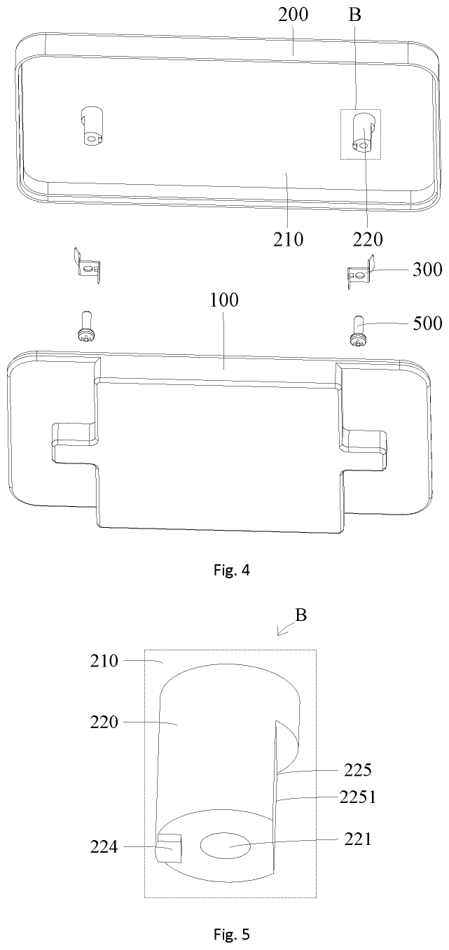

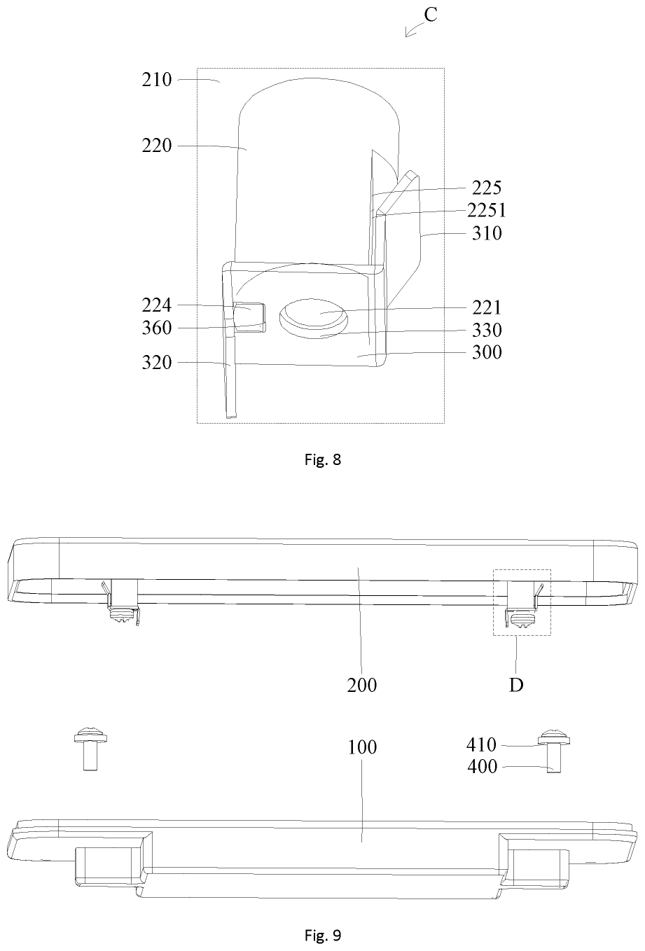

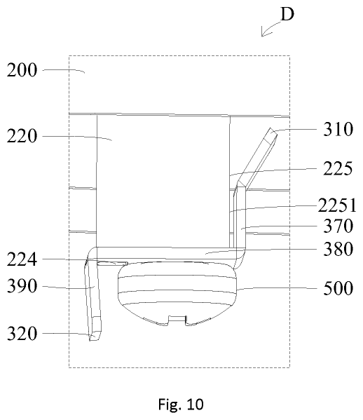

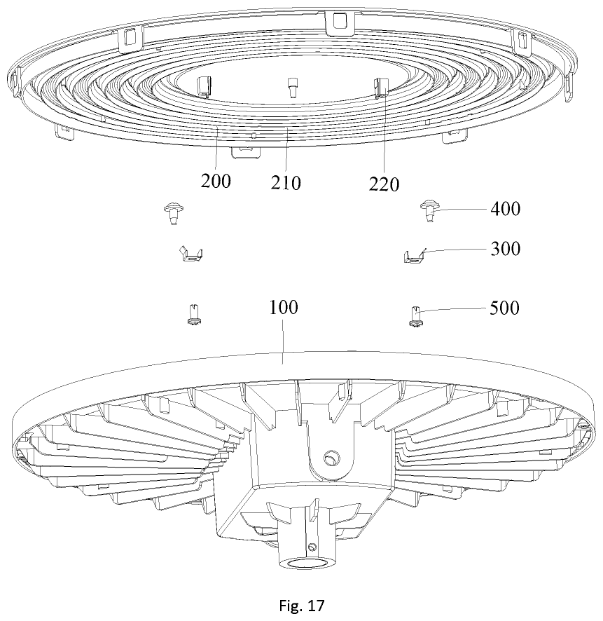

Please refer to FIGS. 1-19, the present disclosure discloses a lighting fixture, which includes a base 100, a lampshade 200, a bent buckle 300, and a first connection member 400. In an example, the lighting fixture can be a ceiling lamp or lamps of other types.

The base 100 is the basic component of the lighting fixture, which can provide the mounting foundation for other components of the lighting fixture, such as the light source of the lighting fixture and the circuit board that provides working current for the light source. The lampshade 200 is used to connect with the base 100, and the light emitted from the light source can exit through the lampshade 200, that is, the lampshade 200 is a light-transmissive lampshade, and of course, the lampshade 200 can also be a lampshade that can distribute light. In the case that the base 100 is connected with the lampshade 200, the base 100 has a first surface 110 facing the lampshade 200, and the lampshade 200 has a second surface 210 facing the base 100, that is, the first surface 110 and the second surface 210 are arranged opposite to each other. One of the first surface 110 and the second surface 210 can be provided with a first mounting hole 120 and a raised stopper 130, the first mounting hole 120 may be a threaded hole, and the stopper 130 may protrude toward the other of the first surface 110 and the second surface 210.

The bent buckle 300 is used to connect the base 100 and the lampshade 200. Specifically, the other of the first surface 110 or the second surface 210 is connected with the bent buckle 300, that is, the bent buckle 300 is arranged on the other of the first surface 110 or the second surface 210, and the first end 310 of the two ends of the bent buckle 300 faces one of the first surface 110 and the second surface 210 that is connected with the bent buckle 300. That is, a part of the bent buckle 300 extends towards one of the first surface 110 and the second surface 210 that is connected with the bent buckle 300, and the stopper 130 provides a lateral position-limiting for the second end 320 of the two ends of the bent buckle 300, that is, the second end 320 and the stopper 130 form a position-limiting fit in the direction in which the second end 320 extends to the stopper 130, and under the mutual restriction between the second end 320 and the stopper 130, the base 100 and the lampshade 200 can be prevented from being separated in the direction in which the second end 320 extends to the stopper 130.

The first connection member 400 is connected with the first mounting hole 120. The first connection member 400 can be a threaded connection member, that is, in this case, the first connection member 400 is screwed with the first mounting hole 120. Specifically, a part of the first connection member 400 is connected with the first mounting hole 120, that is, a part of the first connection member 400 is located in the first mounting hole 120, and another part of the first connection member 400 protrudes from the first mounting hole 120, and is located in a space between the first surface 110 and the second surface 210. Meanwhile, the part of the first connection member 400 protruding from the first mounting hole 120 is located between the first end 310 and one of the first surface 110 and the second surface 210 that is connected with the bent buckle 300, that is, the first end 310 and the first connection member 400 form a position-limiting fit in the thickness direction of the lighting fixture, and under the mutual restriction of the first end 310 and the first connection member 400, the base 100 and the lampshade 200 can be prevented from being separated from each other in the thickness direction, that is, the first end 310 and the first connection member 400 can prevent the base 100 from being separated from the lampshade 200 in the thickness direction, and the direction in which the second end 320 is in position-limiting fit with the stopper 130 is perpendicular to the thickness direction of the lighting fixture, so that the base 100 and the lampshade 200 can be connected through the stopper 130, the bent buckle 300, and the first connection member 400 and cannot be separated.

In one example, the stopper 130 may be a blocking plate, and in this case, the second end 320 and the stopper 130 may be in position-limiting fit in a direction perpendicular to the thickness direction and perpendicular to an extending direction of the stopper 130.

In the present disclosure, because the base 100 has the first surface 110 and the lampshade 200 has the second surface 210, and the first surface 110 and the second surface 210 are arranged opposite to each other, when connecting the base 100 and the lampshade 200, the first mounting hole 120 and the stopper 130 are both located in the space between the base 100 and the lampshade 200. That is, the first connection member 400 connected with the first mounting hole 120 and the bent buckle 300 connected with the first surface 110 or the second surface 210 are both located in the space between the base 100 and the lampshade 200. It can be seen that in the present disclosure, the components connecting the base 100 and the lampshade 200 are located in the space between the base 100 and the lampshade 200, which is beneficial to the lightweight and thinness design of the lighting fixture.

Moreover, because a part of the first connection member 400 is located between the first end 310 of the bent buckle 300 and one of the first surface 110 and the second surface 210 that is connected with the bent buckle 300, the first end 310 and the first connection member 400 form a position-limiting fit in the thickness direction of the lighting fixture, and the stopper 130 provides a lateral position-limiting for the second end 320 of the bent buckle 300. That is, the second end 320 and the stopper 130 form a position-limiting fit in the direction in which the second end 320 extends to the stopper 130. That is, the base 100 and the lampshade 200 are connected and cannot be separated through the cooperation between the bent buckle 300 and the first connection member 400 and the cooperation between the bent buckle 300 and the stopper 130. Therefore, the lighting fixture disclosed by the present disclosure can solve the problem that the connection mode of the lighting fixture related to the related technology is not conducive to the lightweight and thinness design of the lighting fixture.

In addition, because the components that connect the base 100 and the lampshade 200 are all located in the space between the base 100 and the lampshade 200, that is, the stopper 130, the bent buckle 300 and the first connecting member 400 are all located in the space between the base 100 and the lampshade 200, so that the stopper 130, the bent buckle 300, and the first connecting member 400 are not exposed, which makes the lighting fixture disclosed in the present disclosure more beautiful. That is, the appearance effect of the lighting fixture is not easily affected by this connection mode.

In one example, please refer to FIG. 2, the lighting fixture may further include a second connection member 500, which may be a threaded connection member. A mounting post 220 is arranged on and protrudes from the first surface 110 or the second surface 210, and the mounting post 220 is provided with a second mounting hole 221, which may be a threaded hole, and the bent buckle 300 is provided with a first through hole 330. An end of the second connection member 500 passes through the first through hole 330 and is connected with the second mounting hole 221, that is, the first through hole 330 is opposite to the second mounting hole 221, and the second connection member 500 is screwed with the second mounting hole 221, so that the bent buckle 300 is connected with the base 100 or the lampshade 200 through the second connection member 500.

In this example, because the second connection member 500 is connected with the second mounting hole 221, that is, the second connection member 500 has a larger contact area with the mounting post 220, so that the second connection member 500 has a larger contact area with the base 100 or the lampshade 200, thereby ensuring that the bent buckle 300 can be stably mounted on the base 100 or the lampshade 200. Meanwhile, the mounting post 220 makes the bent buckle 300 far away from one of the base 100 and the lampshade 200 on which the mounting post 220 is arranged, which makes the bent buckle 300 closer to the first connecting member 400 and the stopper 130, so as to facilitate the position-limiting fit with the first connecting member 400 and the stopper 130. Of course, the bent buckle 300 can also be directly connected with the first surface 110 or the second surface 210 through the second connection member 500, that is, the first surface 110 or the second surface 210 is not provided with the mounting post 220.

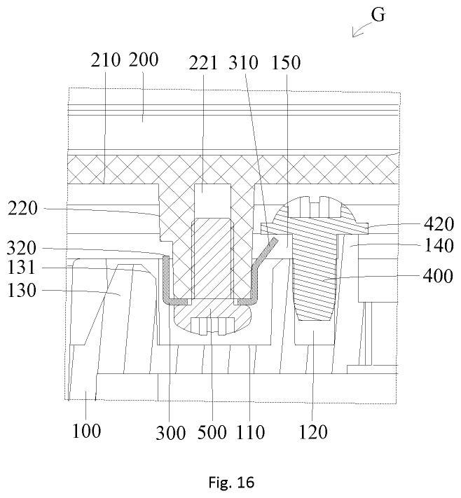

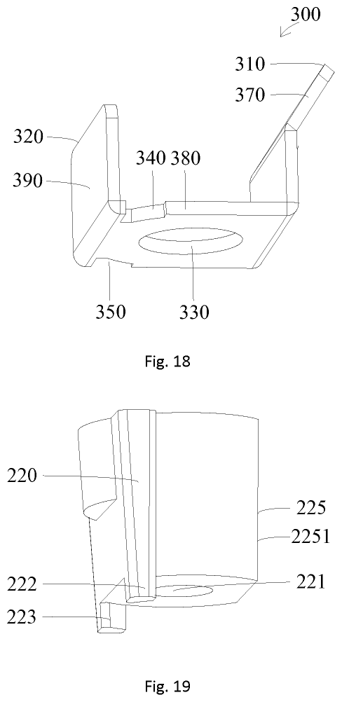

In one example, please refer to FIG. 16, FIG. 18 and FIG. 19, a first protrusion 222 and a second protrusion 223 protrude from the mounting post 220 at intervals. Specifically, the first protrusion 222 and the second protrusion 223 protrude from the top of the mounting post 220 in an area close to the outer peripheral surface of the mounting post 220 at intervals, and two opposite edges of the bent buckle 300 are respectively provided with a first notch 340 and a second notch 350. The first protrusion 222 can pass through the first notch 340 and forms a position-limiting fit with the first notch 340 in the first direction and the second direction, and the second protrusion 223 can pass through the second notch 350 and forms a position-limiting fit with the second notch 350 in the first direction and the third direction, the first direction, the second direction, and the third direction are directions perpendicular to the thickness direction of the lighting fixture, and the second direction is parallel to and opposite to the third direction.

It can be seen that the first protrusion 222 and the second protrusion 223 can limit the position of the bent buckle 300 in the direction perpendicular to the thickness direction through the position-limiting fit of the first protrusion 222 and the first notch 340 and the position-limiting fit of the second protrusion 223 and the second notch 350, so that the bent buckle 300 can be stably arranged on the mounting post 220, that is, the bent buckle 300 can be positioned and mounted on the mounting post 220, so as to facilitate the connection between the bent buckle 300 and the mounting post 220 through the second connection member 500, that is, to ensure the stability of the setting of the bent buckle 300, and further to ensure the stability of the position-limiting fit between the bent buckle 300 and the first connection member 400 and the position-limiting fit between the bent buckle 300 and the stopper 130. Of course, the first protrusion 222 and the second protrusion 223 may not be provided on the mounting post 220.

In one example, the mounting post 220 can be provided with two protrusions, namely the first protrusion 222 and the second protrusion 223 mentioned above.

In another example, please refer to FIG. 5, only one protrusion is provided on the mounting post 220, that is, there is a third protrusion 224 protruding from the mounting post 220, and the bent buckle 300 is further provided with a second through hole 360, which is arranged at intervals from the first through hole 330. At least part of the third protrusion 224 is located in the second through hole 360, so that the third protrusion 224 and the second through hole 360 form a position-limiting fit in the direction perpendicular to the thickness direction of the lighting fixture. That is, through the position-limiting fit of the third protrusion 224 and the second through hole 360, the bent buckle 300 can be limited in two directions at the same time, that is, limited in the direction perpendicular to the thickness direction, which can reduce the number of protrusions on the mounting post 220, thereby reducing the production materials of the protrusions and further reducing the production cost of the mounting post 220, thereby reducing the production cost of the lighting fixture.

In one example, please refer to FIGS. 5 and 19, the peripheral surface of the mounting post 220 is provided with a pre-positioning portion 225 extending along the axial direction of the mounting post 220. The pre-positioning portion 225 has a pre-positioning surface 2251. In the process of connecting the base 100 with the lampshade 200, a part of the bent buckle 300 can be guided and matched with the pre-positioning surface 2251, and the pre-positioning portion 225 can avoid the first end 310. That is, in the process of mounting the bent buckle 300 on the mounting post 220, a part of the bent buckle 300 can contact with the pre-positioning surface 2251, and the pre-positioning portion 225 can avoid the first end 310. In this case, the pre-positioning surface 2251 can provide a guiding function, so that the bent buckle 300 can be easily matched with the mounting post 220 under the action of the pre-positioning surface 2251, and the first through hole 330 and the second mounting hole 221 can be easily made to be opposite to each other, so as to conveniently connect the bent buckle 300 and the mounting post 220 through the second connection member 500.

Meanwhile, because the part of the bent buckle 300 can contact with the pre-positioning surface 2251, that is, the part of the bent buckle 300 is arranged close to the mounting post 220, the whole structure of the bent buckle 300 and the mounting post 220 is compact, which can reduce the space occupied by the whole structure of the bent buckle 300 and the mounting post 220, and setting the pre-positioning portion 225 on the mounting post 220 can reduce the material for producing the mounting post 220, thereby reducing the production cost. Of course, the mounting post 220 may not be provided with the pre-positioning portion 225.

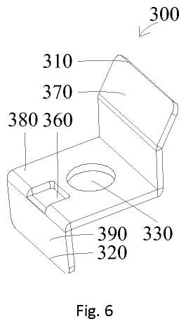

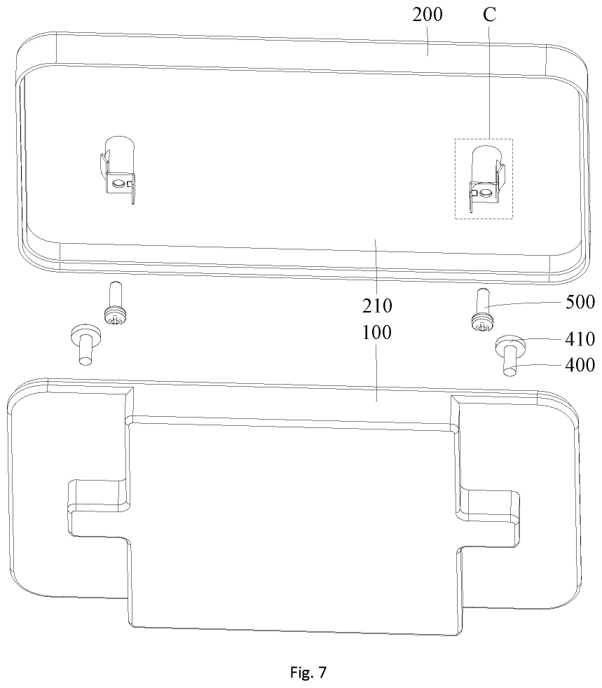

In one example, please refer to FIGS. 1 and 7, because part of the first connection member 400 protrudes from the first mounting hole 120, the first connection member 400 has a third surface 410 facing the first mounting hole 120. Specifically, the first connection member 400 may include a connection portion and a top portion that are connected with each other. A part of the connection portion is connected with the first mounting hole 120, and the top portion is annular and protrudes along the circumferential direction of the connection portion. In this case, the top portion has a third surface 410 facing the first mounting hole 120, so that the first connection member 400 has a third surface 410 facing the first mounting hole 120. Please refer to FIG. 6, the bent buckle 300 may include a first elastic position-limiting plate 370, a connection plate 380, and a second elastic position-limiting plate 390 which are relatively bent and connected in sequence. That is, the bent buckle 300 is an elastic bent buckle, the first elastic position-limiting plate 370 can form a position-limiting fit with the first connection member 400 in the thickness direction. Specifically, the first elastic position-limiting plate 370 forms a position-limiting fit with the third surface 410 in the thickness direction of the lighting fixture, and the connection plate 380 is connected with the first surface 110 or the second surface 210, so that the bent buckle 300 is arranged on the first surface 110 or the second surface 210, the stopper 130 provides a lateral position-limiting for the second elastic position-limiting plate 390. That is, the second elastic position-limiting plate 390 and the stopper 130 form a lateral position-limiting fit in a direction in which the second elastic position-limiting plate 390 extends to the stopper 130.

In the process of assembling the base 100 and the lampshade 200, through the elastic deformation of the first elastic position-limiting plate 370 and the second elastic position-limiting plate 390, the bent buckle 300 can easily form a position-limiting fit with the third surface 410 and the stopper 130, respectively, and in the process of recovering the deformation of the first elastic position-limiting plate 370 and the second elastic position-limiting plate 390, the first elastic position-limiting plate 370 is in contact with and abuts against the third surface 410 so as to realize the position-limiting fit in the thickness direction, and the second elastic position-limiting plate 390 is in contact with and abuts against the stopper 130 so as to realize the position-limiting fit in the direction in which the second elastic position-limiting plate 390 extends to the stopper 130. Of course, the bent buckle 300 may not be an elastic bent buckle, that is, the position-limiting plate of the bent buckle 300 which forms position-limiting fit with the third surface 410 is not an elastic position-limiting plate, and the position-limiting plate of the bent buckle 300 which forms position-limiting fit with the stopper 130 is also not an elastic position-limiting plate.

In one example, please refer to FIGS. 16 and 18, the first elastic position-limiting plate 370 and the second elastic position-limiting plate 390 can be arranged opposite to each other, and both of them extend towards one of the base 100 and the lampshade 200 which is connected with the bent buckle 300, that is, in this case, the bent buckle 300 is generally U-shaped.

In another example, an extending direction of the first elastic position-limiting plate 370 is opposite to that of the second elastic position-limiting plate 390, and the first elastic position-limiting plate 370 extends towards one of the base 100 and the lampshade 200 that is connected with the bent buckle 300. In this case, the second elastic position-limiting plate 390 extends towards the other of the base 100 and the lampshade 200. That is, the second elastic position-limiting plate 390 extends towards the stopper 130 so as to conveniently provide position-limiting fit with the stopper 130 in the direction in which the second elastic position-limiting plate 390 extends to the stopper 130.

It can be seen that, in this example, even if the size of the stopper 130 is small in the thickness direction of the lighting fixture, the second elastic position-limiting plate 390 extends towards the stopper 130, which makes it easy for the second elastic position-limiting plate 390 to form position-limiting fit with the stopper 130. Meanwhile, due to the small size of the stopper 130, that is, less materials are used for the stopper 130, the cost of producing the stopper 130 can be reduced, thereby reducing the production cost of the lighting fixture.

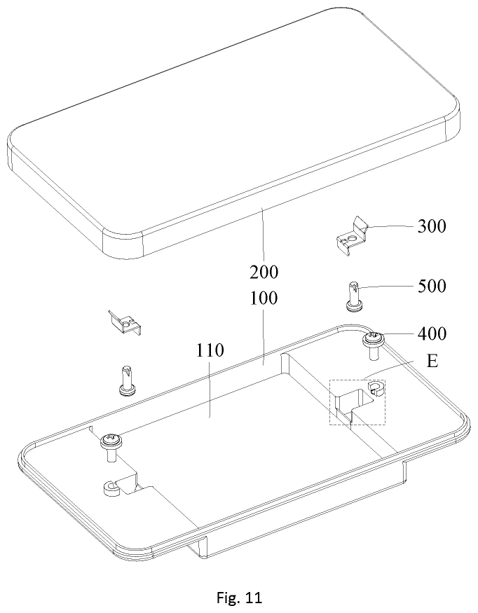

In one example, because a part of the first connection member 400 needs to protrude from the first mounting hole 120, in this case, in order to ensure the mounting stability of the first connection member 400, please refer to FIGS. 11 to 14, the first surface 110 or the second surface 210 is further provided with an arc-shaped protrusion 140 protruding therefrom, and the arc-shaped protrusion 140 is arranged around a part of the first mounting hole 120, and a part of the first connection member 400 is in contact with the arc-shaped protrusion 140. Specifically. The first connection member 400 has a third surface 410 facing the first mounting hole 120, which is the same as the third surface 410 mentioned above, and a part of the third surface 410 is in contact with the arc-shaped protrusion 140, so that the arc-shaped protrusion 140 can support the first connection member 400 to ensure the mounting stability of the first connection member 400.

Meanwhile, because a part of the third surface 410 is in contact with the arc-shaped protrusion 140, an avoidance space 150 can be formed between another part of the third surface 410, the arc-shaped protrusion 140, and the first surface 110. That is, another part of the third surface 410, the arc-shaped protrusion 140, and the first surface 110 can enclose the avoidance space 150, and the first end 310 is located in the avoidance space 150. That is, the arc-shaped protrusion 140 can just avoid bent buckle 300 so as to facilitate the bent buckle 300 to enter the avoidance space 150 to form position-limiting fit with the third surface 410 in the thickness direction. Of course, the first surface 110 or the second surface 210 may not be provided with the arc-shaped protrusions 140.

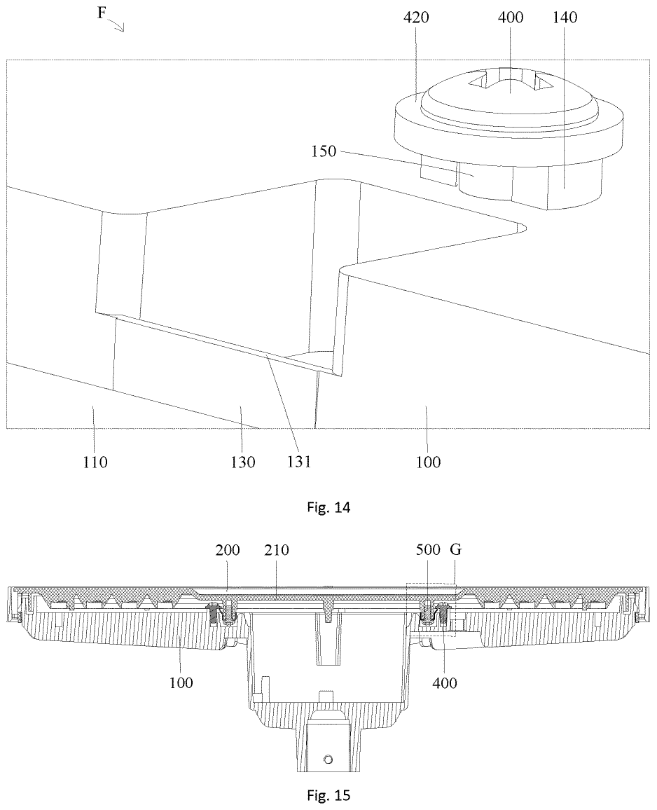

In one example, please refer to FIGS. 13 and 14, the first connection member 400 is provided with a washer 420 with a third surface 410. Because the washer 420 is large in size, the area of the third surface 410 is large, which makes it easier to make the bent buckle 300 contact with and abut against the third surface 410 in the process of connecting the base 100 and the lampshade 200. Of course, the washer 420 may not be provided on the first connection member 400, that is, only the top of the first connection member 400 forms a position-limiting fit with the bent buckle 300.

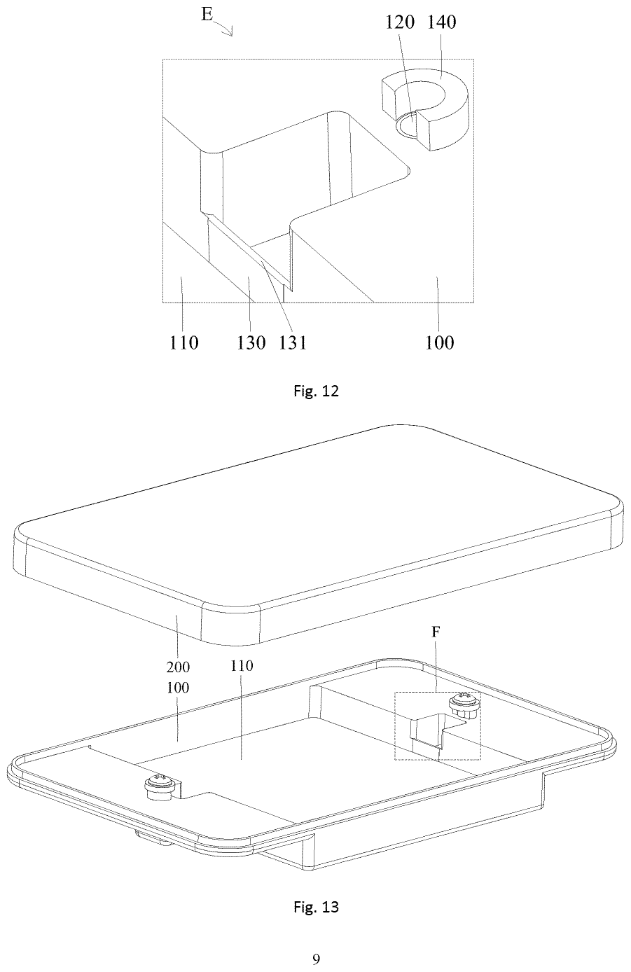

In one example, please refer to FIG. 12 and FIG. 14, a top end of the stopper 130 is provided with a guide inclined surface 131. In the process of connecting the base 100 and the lampshade 200, the second end 320 can be guided and matched with the guide inclined surface 131, which can facilitate the second end 320 to move to the position where the second end 320 form a position-limiting fit with the stopper 130. That is, through the guide inclined surface 131, the second end 320 can smoothly form a position-limiting fit with the stopper 130 in a direction in which the second end 320 extends towards the stopper 130. Of course, the top end of the stopper 130 may not be provided with the guide inclined surface 131. That is, the top end of the stopper 130 may be a horizontal surface.

In one example, the number of bent buckles 300 can be at least two, and each bent buckle 300 is used to connect the base 100 and the lampshade 200, and respective bent buckles 300 can be arranged in the space between the base 100 and the lampshade 200 at intervals. By connecting the base 100 and the lampshade 200 through a plurality of bent buckles 300, the connection stability of the base 100 and the lampshade 200 can be ensured, and this further ensures that the base 100 and the lampshade 200 are not easily disassembled, thereby preventing the lighting fixture from being pried open manually

The present disclosure provides a lighting fixture including a base, a lampshade, a bent buckle, and a first connection member for connecting the base and the lampshade. The base and the lampshade define opposing first and second surfaces, and one of the first and second surfaces is provided with a first mounting hole and a raised stopper. The bent buckle is connected to the other of the first and second surfaces such that a first end of the bent buckle cooperates with the first connection member to provide positioning in a thickness direction of the lighting fixture, while a second end of the bent buckle cooperates with the stopper to provide lateral positioning. The first connection member, the bent buckle, and the stopper are arranged within a space between the base and the lampshade, thereby providing a concealed connection structure that securely connects the base and the lampshade without increasing the overall thickness of the lighting fixture. In some embodiments, the bent buckle is elastically deformable and cooperates with a mounting post, positioning features, and guide structures to facilitate assembly and improve connection stability. The concealed connection arrangement contributes to a compact, low-profile lighting fixture while maintaining reliable mechanical connection and an improved exterior appearance.

The above example of the present disclosure focuses on the differences between the various examples, and the different optimization features among the various examples can be combined to form another example as long as they are not contradictory. For the sake of brevity, details will not be repeated herein.

The above is only examples of the present disclosure, and is not used to limit the present disclosure. Various modifications and variations will occur to those skilled in the art. Any modification, equivalent substitution, improvement, etc. made within the spirit and principle of the present disclosure should be included in the scope of the present disclosure.

1. A lighting fixture, comprising:
a base having a first surface;
a lampshade having a second surface arranged opposite to the first surface, one of the first surface and the second surface being provided with a first mounting hole and a raised stopper;
a bent buckle connected with the other of the first surface and the second surface, wherein a first end of the bent buckle faces the first surface and the second surface connected with the bent buckle, the stopper providing lateral positioning for a second end of the bent buckle;
a first connection member connected with the first mounting hole, wherein a part of the first connection member is located between the first end and the first surface and the second surface connected with the bent buckle.

2. The lighting fixture according to claim 1, further comprising a second connection member, wherein a mounting post is arranged on and protrudes from the first surface or the second surface, and the mounting post is provided with a second mounting hole, and the bent buckle is provided with a first through hole, an end of the second connection member passes through the first through hole and is connected with the second mounting hole, so that the bent buckle is connected with the base or the lampshade through the second connection member.

3. The lighting fixture according to claim 2, wherein a first protrusion and a second protrusion protrude from the mounting post at intervals, and two opposite edges of the bent buckle are provided with a first notch and a second notch, respectively, the first protrusion can pass through the first notch and forms a position-limiting fit with the first notch in a first direction and a second direction, the second protrusion can pass through the second notch, and forms a position-limiting fit with the second notch in the first direction and a third direction, wherein the first direction, the second direction, and the third direction are directions perpendicular to a thickness direction of the lighting fixture, and the second direction is parallel to the third direction and opposite to the third direction.

4. The lighting fixture according to claim 2, wherein the mounting post is provided with a third protrusion protruding therefrom, and the bent buckle is further provided with a second through hole, and at least a part of the third protrusion is located in the second through hole so as to form a position-limiting fit between the third protrusion and the second through hole in a direction perpendicular to a thickness direction of the lighting fixture.

5. The lighting fixture according to claim 2, wherein a peripheral surface of the mounting post is provided with a pre-positioning portion extending along an axial direction of the mounting post, and the pre-positioning portion has a pre-positioning surface, in a process of connecting the base and the lampshade, a part of the bent buckle can be guided and matched with the pre-positioning surface, and the pre-positioning portion can avoid the first end.

6. The lighting fixture according to claim 1, wherein the bent buckle comprises a first elastic position-limiting plate, a connection plate, and a second elastic position-limiting plate bent relative to one another and connected in sequence, and the first connection member has a third surface facing the first mounting hole, the first elastic position-limiting plate and the third surface form a positioning engagement in a thickness direction of the lighting fixture, the connection plate is connected with the first surface or the second surface, and the stopper provides lateral positioning for the second elastic position-limiting plate.

7. The lighting fixture according to claim 6, wherein an extending direction of the first elastic position-limiting plate is opposite to that of the second elastic position-limiting plate.

8. The lighting fixture according to claim 1, wherein the first surface or the second surface is further provided with an arc-shaped protrusion protruding therefrom, and the arc-shaped protrusion is arranged around a part of the first mounting hole, and the first connection member has a third surface facing the first mounting hole, a part of the third surface is in contact with the arc-shaped protrusion so that the arc-shaped protrusion supports the first connection member, and another part of the third surface, the arc-shaped protrusion, and the first surface form an avoidance space.

9. The lighting fixture according to claim 8, wherein the first connection member is provided with a washer, and the washer has the third surface.

10. The lighting fixture according to claim 1, wherein a top end of the stopper is provided with a guide inclined surface, and the second end is guided and matched with the guide inclined surface in a process of connecting the base and the lampshade.

11. The lighting fixture according to claim 1, wherein the first connection member, the bent buckle, and the stopper are all located between the base and the lampshade.

12. The lighting fixture according to claim 11, wherein the first connection member, the bent buckle, and the stopper are concealed from outside the lighting fixture.
